(19) United States
(12) Patent Application Publication
(10) Pub. No.: US 2025/0151658 A1
(43) Pub. Date: May 15, 2025

(54) BLOWER ASSEMBLY FOR A CLEANING DEVICE OF A COMBINE HARVESTER

(71) Applicant: DEERE & COMPANY, Moline, IL (US)

(72) Inventors: Dhairya Sankhla, Mannheim (DE); Swarupanand Patil, Mannheim (DE); Jeffrey R. Walter, Mannheim (DE); Matthew D. Schluenz, Mannheim (DE); Gregory McCunn, Mannheim (DE)

(21) Appl. No.: 18/822,726

(22) Filed: Sep. 3, 2024

(30) Foreign Application Priority Data
Nov. 9, 2023 (DE) 102023131103.4

(51) Int. Cl. A01F 12/44; F04D 17/16

(52) U.S. Cl. CPC A01F 12/444; F04D 17/16

(57) ABSTRACT

A blower assembly for a cleaning device of a combine harvester may include a blower rotor that can be rotated by a drive around a rotation axis, and a housing enclosing the blower rotor. The housing may include two side walls oriented at least approximately radially to the axis of rotation such that each of the side walls has a central air inlet opening arranged axially to the blower rotor and an outer wall of the housing may extend in the circumferential direction of the blower rotor. The outer wall may include at least one outlet opening to which an outlet channel is arranged tangentially to the blower rotor is connected. The housing may be equipped with at least one corrugation or rib.

### CROSS-REFERENCE TO RELATED APPLICATIONS

This application claims priority to German Patent Application Ser. No. 102023131103.4, filed Nov. 9, 2023, the disclosure of which is hereby incorporated by reference in its entirety.

### DESCRIPTION

The disclosure relates to a blower assembly for a cleaning device of a combine harvester.

### BACKGROUND

Combine harvesters are used to harvest grain-like fruits. Plants standing in a field or their fruits are picked up or cut off by means of a harvesting attachment or separated from the plants and fed into a threshing and separating device in order to separate the fruit (e.g. grain) from the other components of the harvested material. After the threshing and separating process, there are still impurities in the grain, such as straw particles and chaff. The mixture of grain and impurities obtained during threshing and separating is therefore fed into a cleaning system, which usually includes an upper and lower sieve and optionally a chaffer.

The sieves are usually suspended from front and rear hangers and are moved by means of an eccentric drive. In this way, the sieves are put into a pendulating back-and-forth motion, moving forward and backward and up and down on elliptical or circular paths. In addition, they are supplied with an air flow from below by means of a blower assembly. In this way, the mixture is periodically thrown upwards on the sieve (at the upper reversal point of the sieve) and lands back on the sieve after covering a throwing parabola. Due to the airflow and the impact on the sieve after the flight, the heavier grain is separated from the lighter impurities.

### SUMMARY

A blower assembly for a cleaning device of a combine harvester may include a blower rotor which can be rotated by means of a drive around an axis of rotation and a housing containing the blower rotor with two side walls oriented at least approximately radially to the axis of rotation, each of which has an air inlet opening in the centre axially to the blower rotor and with an outer wall of the housing extending in the circumferential direction of the blower rotor, comprising at least one outlet opening connected to an outlet channel arranged tangentially to the blower rotor. It is suggested that the housing is provided with at least one corrugation and/or rib.

In this way, the housing is stabilized against warping and can be manufactured with a lower wall thickness.

### BRIEF DESCRIPTION OF THE DRAWINGS

The drawings show an embodiment of the disclosure described in more detail below. It shows:

FIG. 1 is one schematic side view of a combine harvester,

FIG. 2 is a perspective view of the blower assembly of the cleaning device of the combine harvester of FIG. 1 with the inlet rings removed,

FIG. 3 is a perspective view of the housing of the blower assembly of FIG. 2,

FIG. 4 is the view shown in FIG. 3 with a cut-open housing,

FIG. 5 is a section along line 5-5 of FIG. 4,

FIG. 6 is a perspective view of the end of the upper outlet channel,

FIG. 7 is a view of a corrugation with air flowing by, and

FIG. 8 is a view of FIG. 7, but with a differently shaped corrugation.

### DETAILED DESCRIPTION

The embodiments of the present disclosure described below are not intended to be exhaustive or to limit the disclosure to the examples provided in the following detailed description. Rather, the embodiments are chosen and described so that others skilled in the art may appreciate and understand the principles and practices of the present disclosure.

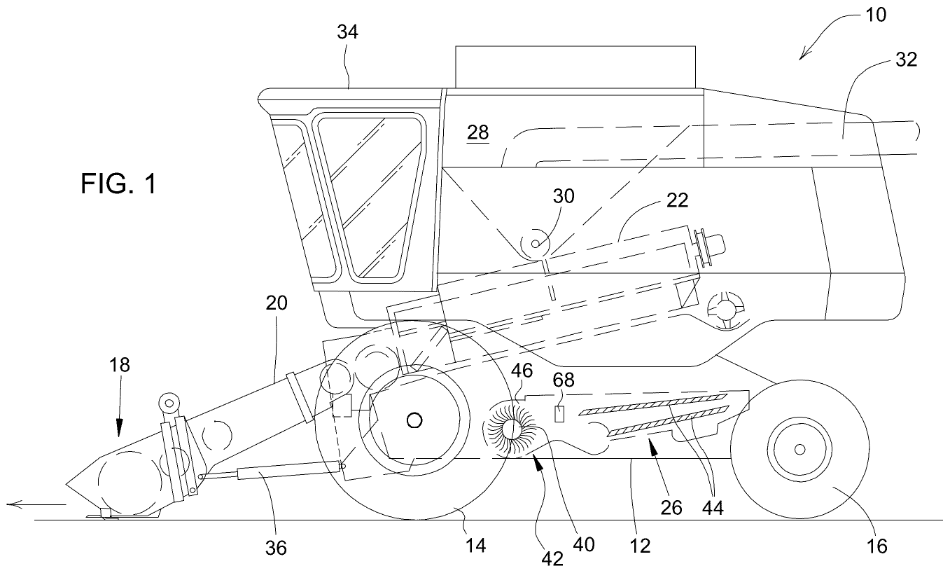

FIG. 1 shows a self-propelled harvester in the form of a combine harvester 10 with a chassis 12 supported on the ground by driven front wheels 14 and steerable rear wheels 16 and propelled by them. Wheels 14 and 16 are rotated by means of driving devices that are not shown, in order to move the combine harvester 10, for example, over a field to be harvested. In the following, directional indications, such as front and rear, refer to the direction of travel V of the combine harvester 10 in the harvesting operation, which runs to the left in FIG. 1.

A detachable harvester attachment 18 in the form of a platform is connected to the front-end area of the combine harvester 10 in order to harvest crops in the form of grain or other threshing stalks from the field during the harvesting operation and to feed it upwards and backwards through a feederhouse assembly 20 to an axial threshing unit 22. The mixture, which passes through threshing concaves and grates in the axial threshing unit 22 and contains grains and impurities, enters a cleaning device 26. Grain cleaned by the cleaning device 26 is fed by means of a grain auger to a grain elevator, which transfers it to a grain tank 28. The cleaned grain from grain tank 28 can be unloaded through an unloading system with a cross auger 30 and an unloading conveyor 32. These systems are powered by an internal combustion engine and controlled and controlled by an operator from a cab 34.

Cleaning device 26 comprises, as is well known, an upper sieve 44 and a lower sieve 44, which are actuated by a blower assembly 42 with a blower rotor 40 and a housing 46 enclosing the blower rotor 40 with an air flow flowing through the sieves 44 to the rear and up. The size of the sieve openings and the speed of the blower rotor 40, which can be rotated by means of a variable speed drive 68 around its axis extending horizontally and transversely to the forward direction, can be changed in a familiar manner by means of an automatic cleaning adjustment system or by the operator from the driver's cab 34.

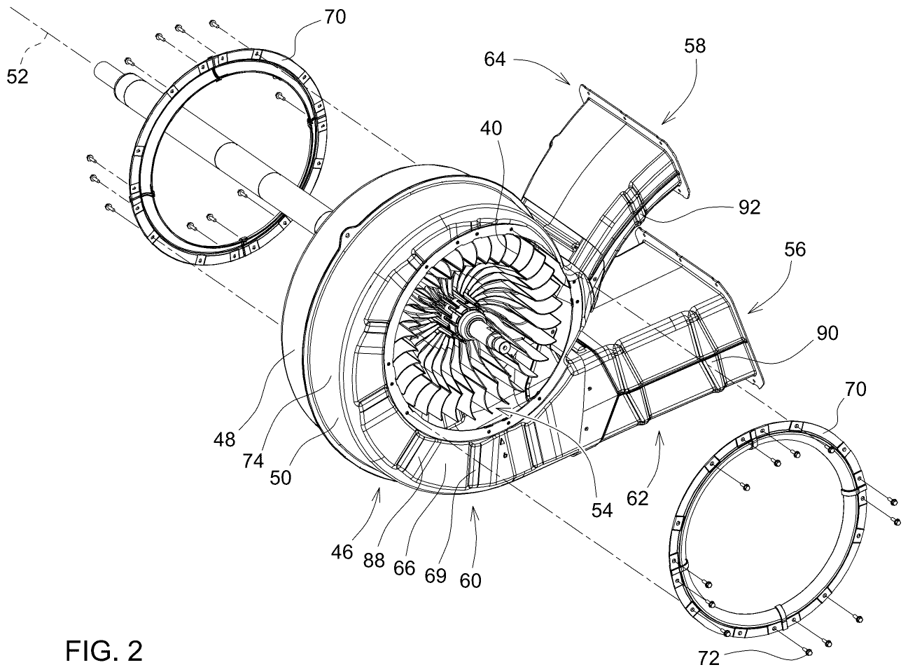

Reference is now made to FIG. 2, which shows a perspective view of housing 46. Housing 46 consists of two halves 48, 50, which are manufactured in a mirror-symmetrical manner to the longitudinal median plane of housing 46, in particular by injection or rotational molding. Halves 48 and 50 are preferably made of plastic and are connected to each other in any way, e.g., by gluing or using mechanical fasteners. Furthermore, the outlet channels 62, 64 are components of the housing 46 and are manufactured separately and attached to the rest of the housing 46.

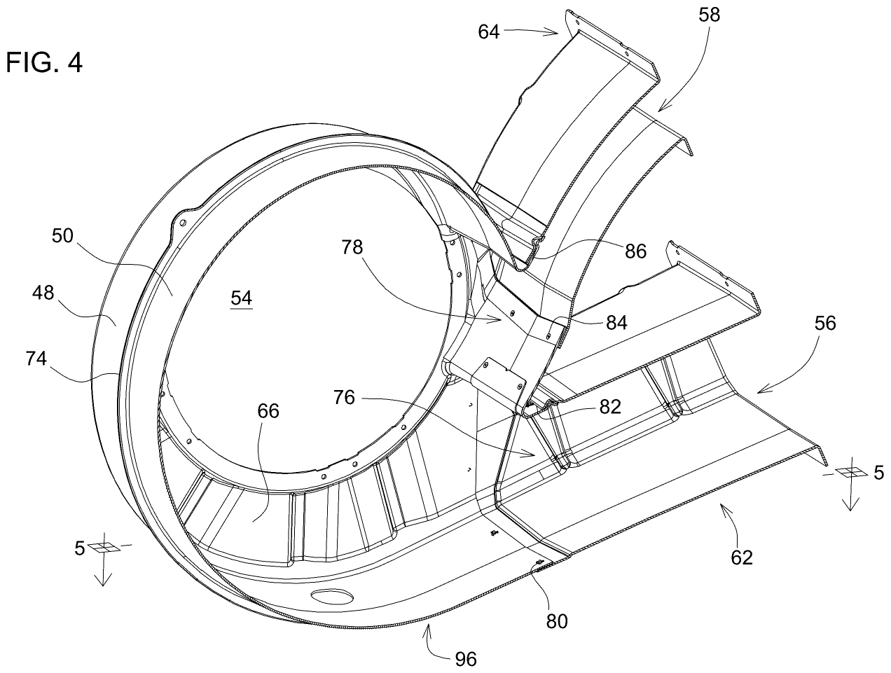

Housing 46 forms an essentially cylindrical area 60 within which the blower rotor 40 is placed, as well as a first, lower outlet channel 62 with a first air outlet 56 directed towards the lower sieve 44 and a second, upper outlet channel 64 with a second air outlet 58 directed towards the upper sieve 44. Area 60 of housing 46 comprises an air inlet opening 54 on each of the two side walls 66 (of which only one is visible in FIG. 2), which defines a central axis 52. This axis 52 corresponds at least approximately to the axis of rotation of the blower rotor 40 arranged in housing 46, i.e. both axes can be arranged coaxially, although it would also be conceivable to offset the axis of the blower rotor 40 relative to axis 52 in the forward and/or vertical direction relative to each other. In the axial direction, the blower rotor 40 is centrally located in housing 46. In the circumferential direction, the blower rotor 40 is enclosed by an outer wall 74 of housing 46. The outer wall 74 is interrupted by outlet openings 76, 78, each of which is connected to an outlet channel 62 or 64, as can be seen in particular in FIG. 4. The outlet channels 62, 64 are plugged onto sections 80 to 86 of housing 46 adjacent to the outlet openings 76, 78 or are otherwise attached to them. The outlet channels 62, 64 are therefore manufactured separately from the housing 46 and attached to it.

As a rule, there are a number of housings 46 with blower rotors 40 arranged in them distributed over the width of the cleaning device 26 in a familiar manner. The blower rotors 40, each of which is arranged in housings 46, can be mounted on a single, common shaft or one or more blower rotors are each assigned a shaft, which makes it possible to adjust their speeds separately.

During operation, the blower rotor 40 rotates counterclockwise in the figures and draws in air from the environment through its blades on both sides through the air inlet openings 54 essentially in the axial direction (with respect to axis 52). This air is conveyed in a tangential direction through the blower rotor 40 and discharged in a tangential direction through the air outlets 56, 58.

It can be seen that the blower rotor 40 is to be inserted into the housing 46 through the air inlet opening 54 when assembling the blower assembly 42. Therefore, the diameter of the blower rotor 40 cannot be larger than the diameter of the air inlet openings 54. However, if the air inlet openings 54 are therefore larger than the envelope circle diameter of the blower rotor 40, this would have a detrimental effect on the aerodynamic properties of the blower assembly 42, because an air inlet opening 54 that is too large would cause the sucked-in air in the outer area of the air inlet opening 54 to be released through the latter as well. Accordingly, in order to enable the installation of blower rotor 40 in housing 46, but to keep the air inlet openings 54 sufficiently small for aerodynamic reasons, an inlet ring 70 is attached to the side walls 66, adjacent to the air inlet opening 54, which extends radially inwards from the inner edge of the air inlet opening 54 in the side walls 66 of housing 46. In particular, the inlet ring 70 forms a cone, i.e. it is angled inwards, towards the blower rotor 40. The inlet ring 70 is mounted only after the blower rotor 40 has been installed in the housing 46. In this way, the aerodynamics of the blower assembly 42 are improved compared to an arrangement without an inlet ring 70. In the embodiment shown, the inlet ring 70 is fastened by screws 72 to brackets 69, which are designed as threaded clips which are pushed onto the inner side wall 66 of housing 46 adjacent to the inlet opening 54.

As already explained, housing 46, including outlet channels 62, 64, is made of plastic. A number of corrugations 88 in the side walls 66 of the housing 46 and corrugations 90, 92 in the side walls of the outlet channels 62, 64 are used for stiffening.

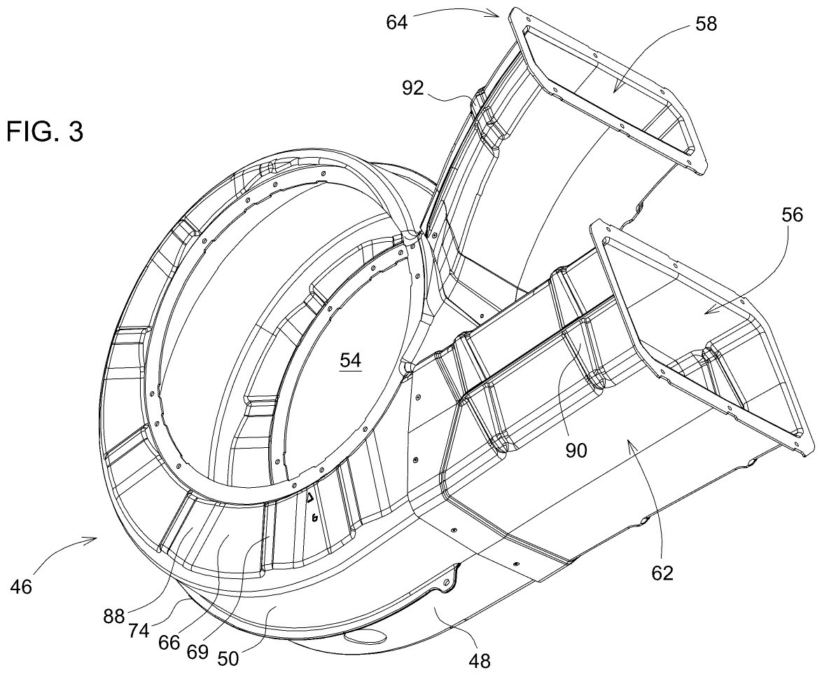

The corrugations 88 in the side walls 66 of housing 46 extend in a radial direction, starting from the area of the edge of the air inlet opening 54, to which the inlet ring 70 is attached, almost to the outer wall 74. In the embodiment shown, cf. in particular FIG. 3, seven corrugations 88 are distributed around the side walls 66 in the circumferential direction, with approximately equal distances, although different numbers of corrugations 88 and different distances would be possible. Since the side walls 66 expand radially outwards in the direction of rotation of the blower rotor 40, starting from the upper exhaust opening 78, the corrugations 88 are also of different lengths. Analogously, the corrugations 90, 92 of the outlet channels 62, 64 extend transversely to the longitudinal axis of the outlet channels 62, 64 and thus also transversely to the direction of flow of the air in them.

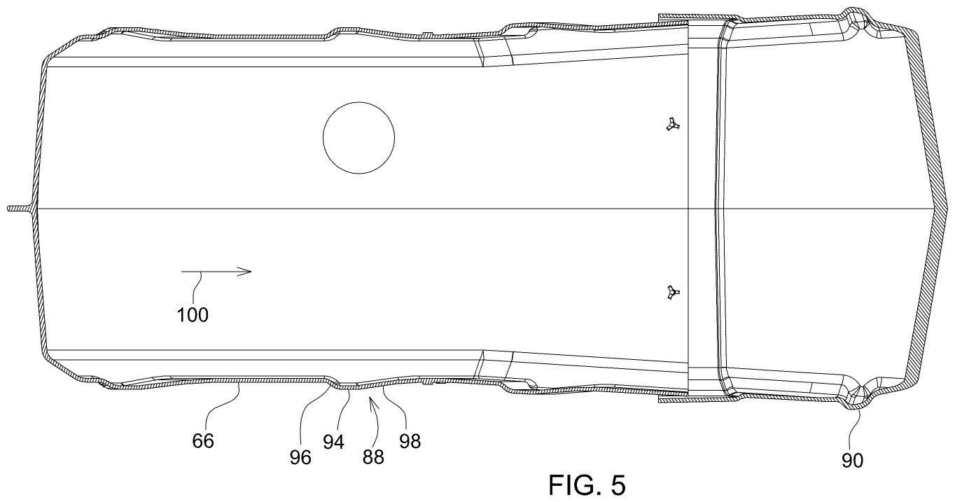

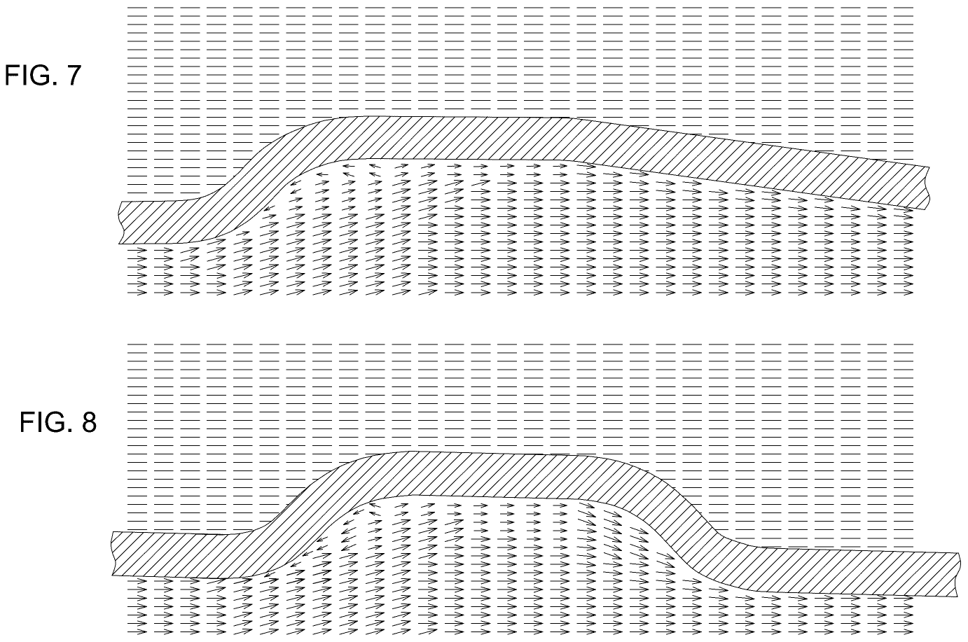

The shape of corrugation 88 can be seen more in more detail in FIG. 5, for example. The corrugations 88 are formed by areas of the side walls 66, which are shifted outwards in relation to the other side walls 66. The corrugations 88 comprise a leading area 96 with respect to the air flow (cf. the arrow 100 in FIG. 5), a trailing area 98 and an intermediate area 94 extending parallel to the adjacent side wall 66 of housing 46. The leading area 96 includes a larger angle with the side wall 66 than the trailing area 98. In other words, the trailing area 96 extends relatively steeply outwards, while the trailing area 98 extends relatively flat inwards. The arrangement of areas 94 to 98 has the advantage over a symmetrical arrangement that the air flow is less swirling, as can be seen from FIGS. 7 and 8.

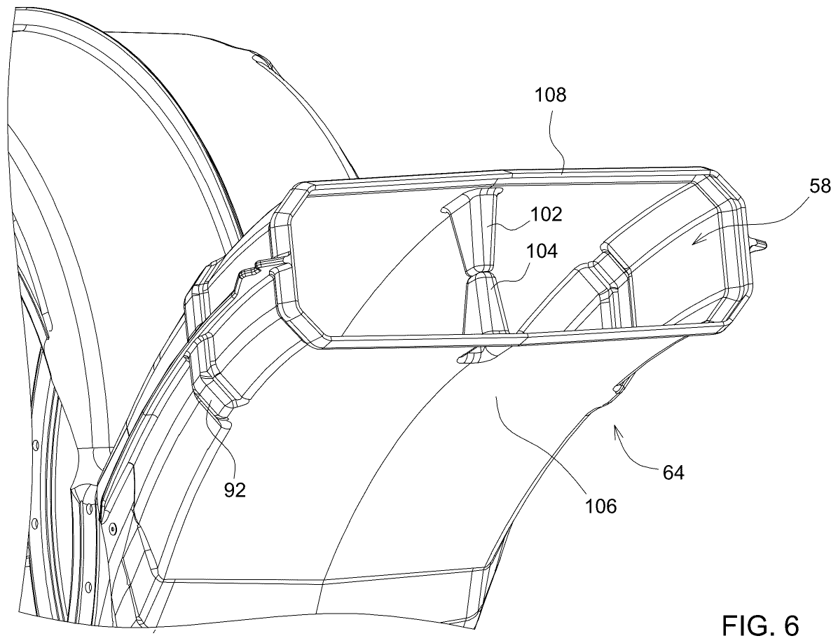

The corrugations 90, 92 in the outlet channels 62, 64 are less critical and can be symmetrically shaped, as can be seen in FIGS. 5 and 6.

FIG. 6 further shows that in the upper outlet channel 64, adjacent to the air outlet 58, between the lower wall 106 and upper wall 108 of the upper outlet channel 64, ribs 102, 104 are provided. The lower wall 106 carries the rib 102 and the upper wall 108 the rib 104. These ribs 102, 104 meet each other and prevent the outlet channel 64 from warping. The entire outlet channel 64 can be made as a single, one-piece (injection) casting, or it can consist of a lower and upper half that are joined together. An analogous procedure is also possible for the lower outlet channel 62.

It should also be noted that instead of the corrugations 88 (or in addition to them) on the outside of the side walls 66, ribs can be used, which also serve to stabilize the housing 46. The insides of the side walls would then be smooth, as long as there are no corrugations.

1. A blower assembly for a cleaning device of a combine harvester, comprising:
a blower rotor configured to be rotated by a drive about a rotation axis; and
a housing enclosing the blower rotor, the housing comprising two side walls oriented at least approximately radially to the axis of rotation, where each of the side walls has a central air inlet opening arranged axially to the blower rotor;
wherein the housing comprises an outer wall extending in the circumferential direction of the blower rotor;
wherein the outer wall comprises at least one outlet opening to which an outlet channel is arranged tangentially to the blower rotor is connected;
wherein the housing comprises at least one corrugation or rib.

2. The blower assembly according to claim 1, wherein one or more corrugations is arranged in a side wall of the housing or a side wall of the outlet channel.

3. The blower assembly according to claim 2, wherein the one or more corrugations arranged in the side wall of the housing is oriented radially to the blower rotor.

4. The blower assembly according to claim 3, wherein the one or more corrugations is shaped outwards in relation to the housing.

5. The blower assembly according to claim 4, wherein the one or more corrugation comprises a leading area with respect to the air flow, a trailing area and an intermediate area extending parallel to the adjacent side wall of the housing;
wherein the leading area enclosing a greater angle with the side wall than the trailing area.

6. The blower assembly according to claim 2, wherein the one or more corrugations arranged in the outlet channel is oriented transversely to the longitudinal direction of the outlet channel.

7. The blower assembly according to claim 6, wherein the one or more corrugation comprises a leading area with respect to the air flow, a trailing area and an intermediate area extending parallel to the adjacent side wall of the outlet channel;
wherein the leading area encloses a greater angle with the side wall than the trailing area.

8. The blower assembly according to claim 1, wherein the at least one rib is located at an end of the outlet channel and extends between a lower wall and an upper wall of the outlet channel.

9. The blower assembly according to claim 8, wherein the rib is configured to support a lower and upper part of the outlet channel against warping.

10. The blower assembly according to claim 1, wherein the housing is formed of plastic.

11. A combine harvester, comprising:
a chassis;
a cleaning device comprising an upper sieve, a lower sieve, and a blower assembly, the blowing assembly actuating the upper sieve and lower sieve;
wherein, the blower assembly comprises:
a blower rotor configured to be rotated by a drive about a rotation axis; and
a housing enclosing the blower rotor, the housing comprising side walls oriented radially to the axis of rotation, where the side walls have a central air inlet opening arranged axially to the blower rotor;
wherein the housing comprises an outer wall extending in the circumferential direction of the blower rotor;
wherein the outer wall comprises at least one outlet opening being connected to an outlet channel;
wherein the housing comprises a corrugation or a rib.

12. The combine harvester according to claim 11, wherein the corrugation is arranged in a side wall of the housing or a side wall of the outlet channel.

13. The combine harvester according to claim 12, wherein the corrugation arranged in the side wall of the housing is oriented radially to the blower rotor.

14. The combine harvester according to claim 11, wherein the corrugation comprises a leading portion with respect to the air flow, a trailing portion and an intermediate portion extending parallel to the side wall of the housing;
wherein the leading portion encloses a greater angle with the side wall than the trailing portion.

15. The combine harvester according to claim 12, wherein the corrugation arranged in the outlet channel is oriented transversely to the longitudinal direction of the outlet channel.

16. The combine harvester according to claim 11, wherein the rib is located at an end of the outlet channel and extends between a lower wall and an upper wall of the outlet channel.

17. The combine harvester according to claim 16, wherein the rib is configured to support a lower and upper part of the outlet channel against warping.

18. A combine harvester, comprising:
a chassis;
a cleaning device comprising an upper sieve, a lower sieve, and a blower assembly, the blowing assembly actuating the upper sieve and lower sieve; and
a drive;
wherein, the blower assembly comprises:
a blower rotor configured to be rotated by the drive about a rotation axis; and
a housing enclosing the blower rotor, the housing comprising a side wall oriented radially to the axis of rotation, where the side wall includes an air inlet opening arranged axially to the blower rotor;
wherein the housing comprises an outer wall extending in the circumferential direction of the blower rotor;
wherein the outer wall comprises at least one outlet opening connected to an outlet channel;
wherein the housing comprises a corrugation or a rib.

19. The combine harvester according to claim 18, wherein the corrugation is arranged in a side wall of the housing or a side wall of the outlet channel.

20. The combine harvester according to claim 18, wherein the corrugation comprises a leading portion with respect to the air flow, a trailing portion and an intermediate portion extending parallel to the side wall of the housing;
wherein the leading portion encloses a greater angle with the side wall than the trailing portion.
